(19) United States
(12) Patent Application Publication
(10) Pub. No.: US 2016/0055370 A1
(43) Pub. Date: Feb. 25, 2016

(54) System and Methods of Generating User Facial Expression Library for Messaging and Social Networking Applications

(71) Applicant: Futurewei Technologies, Inc., Plano, TX (US)

(72) Inventor: Jose Garcia, La Mesa, CA (US)

(21) Appl. No.: 14/465,603

(22) Filed: Aug. 21, 2014

(51) Int. Cl. G06K 9/00; H04M 1/725; H04W 4/12

(52) U.S. Cl. CPC G06K 9/00288; G06K 9/00302; H04W 4/12; H04M 1/72552

(57) ABSTRACT

Embodiments are provided that utilize images of users to represent true or personalized emotions for the users in messaging or social networking applications. A library of user facial expression images is generated for this purpose, and made accessible to messaging or social networking applications, such as on a smartphone or other user devices. The images of facial expressions include face photographs of the user that convey emotions or expressions of the user, such as a happy face or a sad face. An embodiment method includes detecting an image accessible by an electronic device, determining whether the image shows a face of the user and whether the image shows a facial expression expressed by the face of the user, adding the image to a library of facial expressions of the user in accordance with the determining step, and sending a message including the image as an emoticon.

### TECHNICAL FIELD

The present invention relates to messaging and social networking, and, in particular embodiments, to system and methods of generating a user facial expression library for messaging and social networking applications.

### BACKGROUND

Messaging and social networking has become widely popular to communicate text and media (e.g., sound, music, video) between users or subscribers. Messaging and social networking applications and services offered by online and/or wireless service providers provide users with various communication features, such as instant chat, instant messages, Short Message Service (SMS) messages, and Multimedia Messaging Service (MMS) messages. The users can use such features to express what's on their mind and current emotions. One way to express users' emotions is by sending, via SMS or instant messages for example, icons or graphics that are expressive of sentiments, emotions, or mind states in general. However, the icons and graphics are typically predefined and preset, e.g., according to the messaging application or service in use, and therefore lack individuality and can become mundane with time. There is a need for improved means to communicate emotions and mind states of users via messaging and social networking applications and services to offer a more personalized and better user experience.

### SUMMARY OF THE INVENTION

In accordance with an embodiment, a method performed by an electronic device associated with a user includes detecting an image accessible by the electronic device, determining whether the image shows a face of the user and whether the image shows a facial expression expressed by the face of the user, and adding the image to a library of facial expressions of the user in accordance with the determining step. The method further includes sending a message including, as an emoticon, the image from the library.

In accordance with another embodiment, a method performed by a network server includes detecting a face of a user in a digital image and a facial expression expressed by the face of the user in the digital image, adding the digital image to a library of digital images portraying facial expressions of the user, and providing an application operated on an electronic device of the user access to the library. The application includes an option to send, from the electronic device, the digital image as an emoticon.

In accordance with yet another embodiment, an electronic device associated with a user comprises at least one processor, a display providing the user interface, and a non-transitory computer readable storage medium storing programming for execution by the at least one processor. The programming includes instructions to detect an image accessible by the electronic device, determine whether the image shows a face of a user and whether the image shows a facial expression expressed by the face of the user, and add the image to a library of facial expressions of the user in accordance with the determining step. The programming includes further instructions to send a message including, as an emoticon, the image from the library.

In accordance with another embodiment a network server comprises at least one processor and a non-transitory computer readable storage medium storing programming for execution by the at least one processor. The programming includes instructions to detect a face of a user in a digital image and a facial expression expressed by the face of the user in the digital image, add the digital image to a library of digital images portraying facial expressions of the user, and provide an application operated on an electronic device of the user access to the library. The application includes an option to send, from the electronic device, the digital image as an emoticon.

In accordance with yet another embodiment, a system comprises an electronic device associated with a user and one or more network servers. The electronic device and the one or more network servers are individually or collectively configured to detect an image accessible by the electronic device, determine whether the image shows a face of the user and whether the image shows a facial expression expressed by the face of the user, and add the image to a library of facial expressions of the user in accordance with the determining step. The library is accessible by an application operated on the electronic device associated with the user. The application includes an option to send, from the electronic device, the digital image as an emoticon.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram illustrating an embodiment of a system for detecting user face images in an image album on a device;

FIG. 2A is a diagram illustrating an embodiment of implementing an option in messaging or social networking applications to insert a user face image corresponding to a desired emotion;

FIG. 2B is a diagram illustrating a view of available user face images as emoticons to a messaging application;

FIG. 3 is a flow diagram illustrating an embodiment method of automatic operations of a system enabling user face images as emoticons;

FIG. 4 is a flow diagram illustrating an embodiment method of handling images using the system of FIG. 3;

FIG. 5 is a diagram of an embodiment system that uses a user facial expression library for messaging and social networking applications;

FIG. 6 is a diagram of another embodiment system that uses a user facial expression library for messaging and social networking applications;

FIG. 7 is a diagram of another embodiment system that uses a user facial expression library for messaging and social networking applications;

FIG. 8 is a diagram of another embodiment system that uses a user facial expression library for messaging and social networking applications; and

FIG. 9 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

System and method embodiments are provided herein that utilize images of users to represent true or personalized emotions or mind states of the users in messaging or other social networking means. As used herein, the term image indicates an artifact that depicts or records visual perception, for example a two-dimensional picture, that has a similar appearance to some subject (e.g., a person), thus providing a depiction of the subject. Images may be two-dimensional, such as a photograph of a person, and may be captured by optical devices, such as cameras, mirrors, lenses, telescopes, microscopes, or others. The images can be stored electronically (e.g., as digital images) on electronic devices with memory, and can be displayed on electronic displays (screens). A set of user emotions or mind states portrayed by a library of images of user facial expressions is generated for this purpose, and linked or made accessible to messaging or social networking platforms/services. The platforms can be software applications or programs (code) usable on a user device or a family of user devices. The services can be offered to users or subscribers by online and/or wireless service providers or operators. The images of user facial expressions show user faces (e.g., face shots) expressing various expressions, emotions, attitudes, or mind states of the user. For example, the images of user facial expressions include a happy face, a sad face, an angry face, and/or other facial expressions. The images can be cropped images of the user faces. The images may be digital images captured via digital cameras, or any other devices or means (e.g., scanners), and stored in digital format, for example on any suitable memory device for storing digital media.

The user facial expression images can be sent, e.g., via texts or instant messages provided by the platforms or services. The platforms and services can include social networking platforms (e.g., Facebook™), instant messaging platforms (e.g., Twitter™, Facebook Messenger™), media exchange platforms (e.g., Instagram,™), Flicker™, text messaging services (e.g., SMS, MMS, WhatsApp™, WeChat™) that are supported on various user devices, or other suitable platforms and services. Examples of user devices include smartphones, computer tablets, laptop computers, and desktop computers. As used herein, the terms messaging and social networking platforms refer to any messaging or social networking applications and services that can be run on various devices in various suitable forms, such as in a web browser on a computer device, via a downloadable application (referred to commonly as an “app”) on a smartphone or tablet, or via any software program/code installed on such devices. The messaging and social networking platforms and services can also be accessed or used via cloud based applications without or with limited download. The applications or programs can be processed on such devices, processed on one or more remote servers (e.g., in the cloud or Internet) and accessed by such devices, processed in a distributed manner between multiple devices/servers, or combinations of such processing models.

Text messaging applications include any applications that allow sending electronic messages between two or more users, such as on mobile phones or fixed or portable devices over wireless service provider networks. The messages can be sent using the Short Message Service (SMS). The messages can also contain image, video, and sound content (known as MMS messages). A client application on each device allows the sending and receiving of such messages. The service should also be supported by the provider's network to enable the devices to send the text messages.

Instant messaging is a type of electronic (online) chat which offers real-time text transmission over the Internet, an Internet Protocol (IP) network, a wireless or cellular network, or other suitable networks. A Local Area Network (LAN) messenger operates in a similar way over a LAN. Instant messaging typically involves transmitting short messages bi-directionally between two or more parties, e.g., when each user chooses to complete a thought and select “send”. Some instant messaging applications can use push technology to provide real-time text, which transmits messages character by character, as they are composed. More advanced instant messaging can add file transfer, clickable hyperlinks, Voice over IP (VoIP), or video chat. Similar to text messaging, a client instant messaging application on each device allows the sending and receiving of such messages. A peer-to-peer protocol can be used to allow the two or more client applications to exchange the messages. Other instant messaging protocols require the clients or peers to connect to a server, e.g., in the cloud or a provider's network.

A social networking platform is a service that builds social relations among people or users who share interests, activities, backgrounds or real-life connections. A social networking service consists of a representation of each user (often a profile), his social links, and a variety of additional services. The social networking service can be a web-based service that is accessed online, via a web-site or an “app”, and that allows users to create a public profile, create a list of users with whom to share connection, and view and cross the connections within the system. Social networking services can provide means for users to interact over the Internet (or other suitable network) such as by e-mail and instant messaging. The social networking service includes a server that manages the connections between users, e.g., connections with the web-sites or “apps” on user devices. The web-sites or “apps” serve as client applications on user devices that interact with the server of the social networking service.

Specifically the system automatically generates a library of images portraying user facial expressions and emotions in a storage space dedicated for the user. As used herein, the term library indicates any suitable logical grouping of the images, e.g., as digital files in a folder or multiple folders, on a local or remote storage accessible by a user device. As such, the library may represent a digital album of images. For instance, the storage space can be at local memory storage on a device, a family or devices, or a remote storage space in the cloud (e.g., remote storage accessible by the Internet) which is associated with the user. The library of user facial expression images can also be localized on one device/location or distributed on multiple devices/locations. Further, multiple copies of the library or images in the library can be stored in multiple devices/locations (e.g., in the cloud and on one or more user devices). The images can be stored in the library of user facial expressions in any image file format suitable for display in the messaging and social networking applications. Examples of image file formats that can be supported include Portable Network Graphics (PNG), Joint Photographic Experts Group (JPEG), bitmap image file (BMP), and Graphics Interchange Format (GIF) or any other format supported on such devices.

In embodiments, the messaging and social networking platforms can include or be linked on the same device with the library of images portraying the user facial expressions. For example, an “app” on a smartphone can connect to the library of images also stored on the same smartphone. In the case of an application hosted by a server, e.g., in the cloud, the same server can also host the library of images. In other embodiments, the application and the library of images can be hosted on different components. For the example, the library can be hosted on a user device (e.g., smartphone) and the application can be hosted on a remote server. Alternatively, the application can be an app on the user device and the library can be hosted remotely, e.g., in the cloud or on another device.

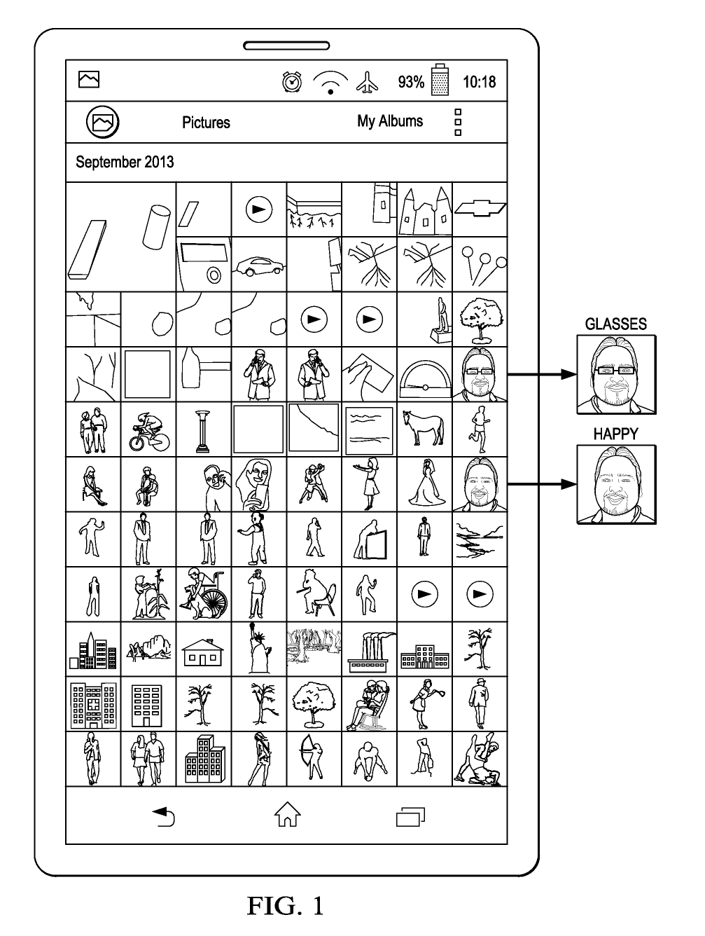

To generate the image library of user facial expressions, any existing image in an image album (e.g., digital folder) associated with the user, taken, uploaded, received, or displayed on a user device is automatically analyzed by a face recognition function. FIG. 1 shows an embodiment of detecting user face images in a general digital album of images on a device, such as a smartphone. The album may be stored on the device, stored remotely (e.g., in the cloud or one or more remote servers or devices) and accessible by the device, or combinations of both. If the face recognition function detects the face of the user in the image, then the image is cropped properly, if needed, to capture the face and then added to the library of user facial expressions. For instance, if the image shows other objects than the user image, the image is cropped around the user face. The face recognition function is trained to recognize the user face by analyzing existing images of the user face. For instance, upon setting up the face recognition function, the user may select one or more user face images existing on the device or the remote storage space to train the face recognition algorithm. The user may also manually add, at any time, one or more user face images to the library, which are then made available to the face recognition function to analyze and further train the face recognition algorithm. In an embodiment, the automatic face recognition function operation may also include prompting the user to confirm the results of the analysis. Upon user confirmation, the user face image is added to the library of user facial expressions images if approved by the user. If the analysis by the function is not conclusive, the user may be given the option to accept the image or reject it. The user may also be capable of adding an image to the library or removing an image at any time.

Each user face image to be added to the library is also automatically analyzed by a facial expression or emotion recognition function. For example as shown in FIG. 1, the face images detected by the face recognition function and added to the library of user facial expressions images are analyzed by the facial expression recognition function, also referred to herein as an emotion recognition function. According to the result of the analysis, the user face image is classified into one of the available facial expression and emotion categories, such as happy, sad, angry, excited, and other possible emotion or facial expression categories. The facial expression recognition algorithm is further trained using existing user face images for each emotion category. In an embodiment, the automatic emotion recognition function operation may also include prompting the user to confirm the result of the analysis. The user face image is hence added to an emotion category if approved by the user. If the analysis by the function is not conclusive, the user may be given the option to add the image to an emotion or facial expression category. The user may also be given the option to add or remove facial expression/emotion categories, and further to move, add, or remove images from the categories.

The implementation of the face recognition function and emotion recognition function may be separate from the messaging and social networking applications/services. The algorithms can be processed on the user device, on one or more remote devices/servers accessed by the user device, in the cloud, or other suitable means. Thus the functions can be processed on one or more entities remote but linked to the messaging and social networking applications. Alternatively, the same one or more devices can implement the functions and the applications/services. In an embodiment, the face recognition function and emotion recognition function may be integrated within the messaging and social networking applications, e.g., as an add-on feature or part of the software.

The system allows the user to display any of the user face images of the library in the messaging or social networking applications. Specifically, an option in the messaging/networking application allows the user to insert, from the library into a text or messaging box of the application, a user face image corresponding to a desired emotion or facial expression. The library of user facial expressions serves as emoticons available to the application, in other words as a dictionary for expressing emotions of the user. The term emoticon refers to any graphical representation of a facial expression that indicates or represents the tenor or temper of a user (the sender). The emoticon can be used in messaging or social networking applications instead of text or words to convey the sender's sentiment, emotion, or state of mind.

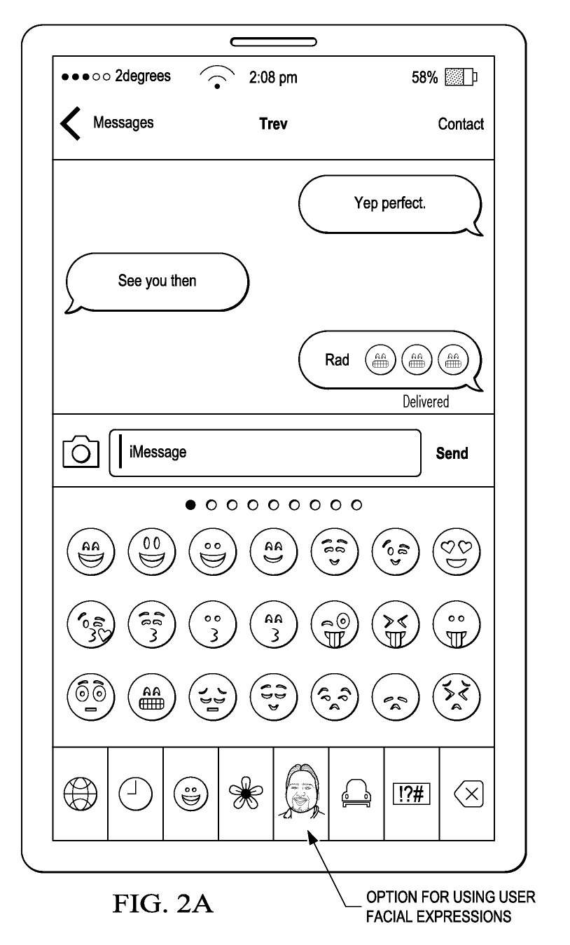

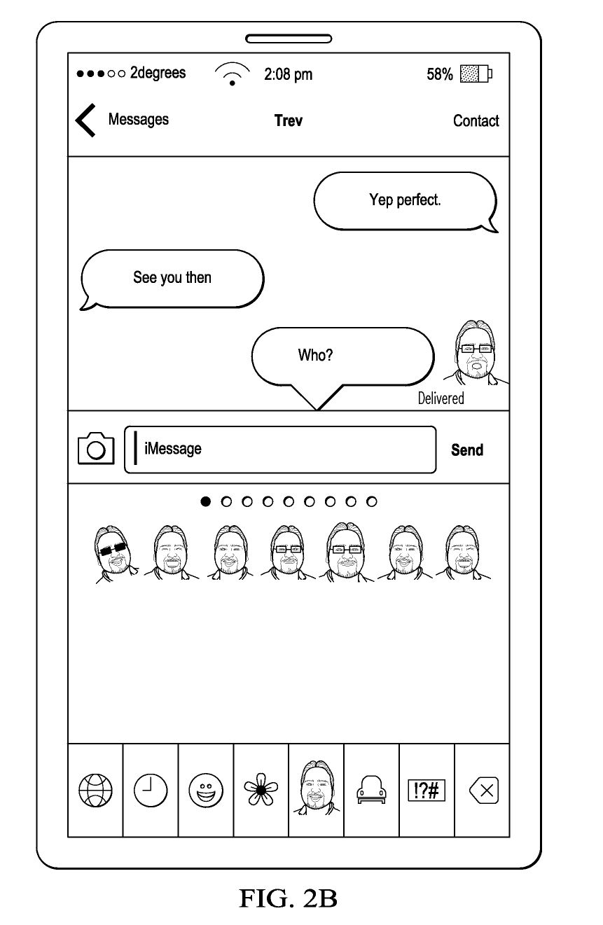

FIG. 2A shows an embodiment of implementing this option in a messaging application. The option is added to the existing options of the application for inserting various types of icons (smiley faces, flowers, cars, symbols). A view of the available user face images as emoticons is displayed when the user selects this option, as shown in FIG. 2B. For example, in FIG. 2A, the user can click or tap on the small user face icon in the bottom row of available options to enter a view of available user facial expression images in FIG. 2B. The displayed user face images represent various emotions or states of the user (e.g., user happy face, angry face, and others), from which the user can select a proper facial expression image that represents the emotion or state the user wishes to convey. The selected image is thus inserted into the text or messaging box above for sending to a corresponding user on the other end of communications or to post in a social networking application, for example.

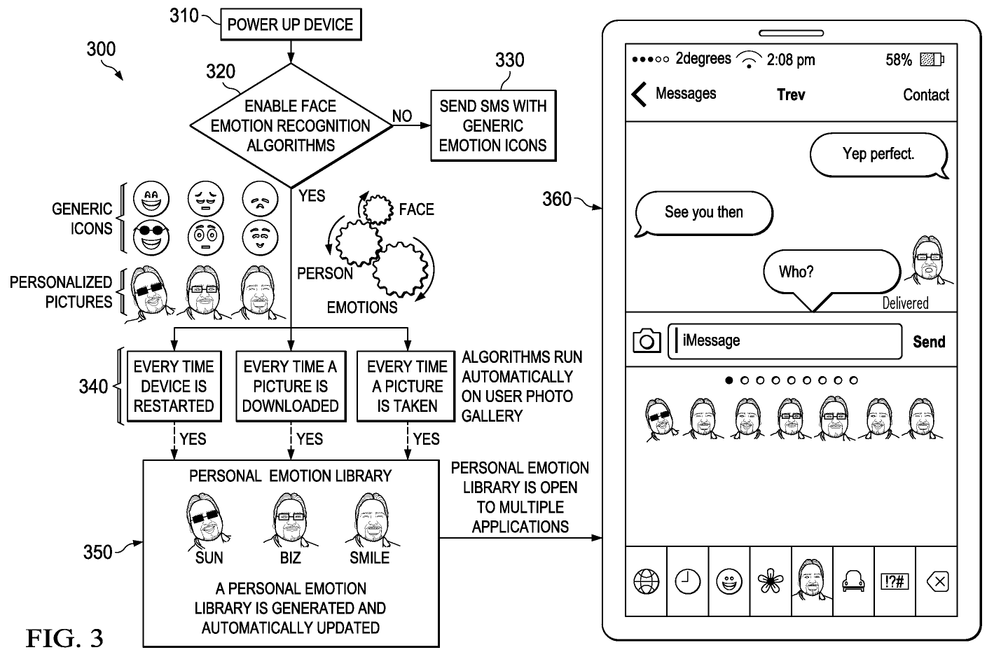

FIG. 3 shows a flow of an embodiment method 300 of automatic operations by a system using user face images as emoticons. The method can be implemented by a user device, such as a smartphone, a computer tablet, a laptop computer or a desktop computer. At step 310, the device is turned on (powered). At step 320, the device determines whether the face and emotion recognition algorithms are enabled. The algorithms may be enabled or disabled by the user as part of the system settings. The applications can be loaded or installed on the device or remotely accessed, e.g., via a remote connection, on a remote server or the Internet (e.g., in the cloud). If the algorithms are disabled, then, at step 330, the applications accessible by the device can use any of the available generic emotion icons (e.g., smileys) that are available to the applications. The applications can be installed on the device or accessed, e.g., via a remote connection, at a remote server or the Internet (e.g., in the cloud). If the algorithms are enabled, then the face and emotion (facial expression) recognition algorithms run automatically, e.g., on one or more album images and images of the user device, at step 340. The one or more albums of images and images can be installed on the device, on multiple devices, remotely (e.g., in the cloud), or combinations thereof. The algorithms can, for example, run each time an image is detected, captured, displayed or downloaded, upon turning on or rebooting the device or when initiated by the user, application, or a remote server. Thus, at step 350, the user library of facial expressions is automatically generated or updated according to the results of the algorithms. At step 360, the library is then made available to the applications. In another embodiment, the method above can be implemented, with suitable variations, by a server running the messaging or social networking application on an account registered to the user.

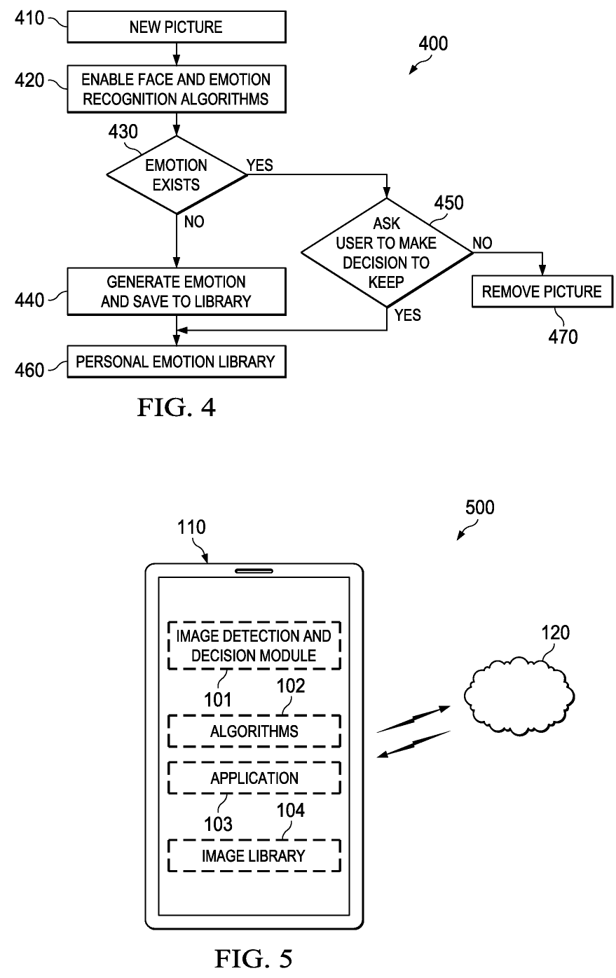

FIG. 4 shows a flow of an embodiment method 400 of handling images in the system described above. The method 400 can be part of the method 300, and can be implemented by a user device. At step 410, a new image is detected. The new image may be a newly downloaded, received, captured or displayed image on the device. In one example, the new image can be added to a remote entity (remote server (in the cloud) or remote device) and detected by the user device. At step 420, the face and emotion recognition algorithms are enabled to process the image. At step 430, the method verifies whether the facial expression or emotion corresponding to the image, according to the result of the algorithms, exists in the library of emotions or facial expressions. If the emotion or facial expression corresponding to the image does not exist in the library, then the emotion or expression is established as a new emotion or expression and the image is added to the library at step 440. This step may include cropping or transforming the image format if needed. The method then updates, at step 460, the personal emotion library accordingly, which is made available to the messaging and social networking applications. Alternatively, if the expression or emotion corresponding to the image does exist, then, at step 450, the user is asked to make a decision on whether to keep the image. If the user decides to keep the image, the method proceeds to step 460 to update the library by adding the image. If the user decides not to keep the image, then the image is removed at step 470. In another embodiment, the method above can be implemented, with suitable variations, by a server running the messaging or social networking application on an account registered to the user.

In various embodiments, the methods described above can be implemented by a user device, multiple devices connected via links, a network device such as a server (e.g., in the Internet or the cloud), or combinations thereof. In an embodiment, the face recognition function, the facial expression or emotion recognition function, the messaging or social networking applications, and the user facial expression library are located on a user device, such as a smartphone or a computer tablet. In another embodiment, the components of the system above are distributed between a user device and one or more remote servers, e.g., in the cloud. For example, the user device hosts the face recognition function and the facial expression recognition function while one or more remote servers host the messaging or social networking applications, which are accessible by the device, e.g., via a wireless/cellular, WiFi, or Internet connection. Alternatively, one or more remote servers host the face recognition function and the facial expression recognition function, which are accessible by the device, while the user device hosts the messaging or social networking applications. The library can be hosted on the user device, the remote server(s), or both. In scenarios where messages are exchanged between the two or more user devices, the methods, functions, and applications can be used as described above on one end by one of the user devices or on both ends.

As described above, the method of detecting a user facial image and expression and accordingly the decision to add the image to the library 104 can be primarily implemented by the user device. FIG. 5 illustrates an embodiment of a system 500 comprising a user device 110, e.g., a smartphone, which communicates with a network 120, e.g., a service provider network, the Internet, or both. The user device 110 includes an image detection and decision module 101, face and facial expression recognition functions or algorithms 102, an application 103 (e.g., a messaging or social network application), and a library 104 of images portraying the user facial expressions. The image detection and decision module 101 detects an image accessed by the device 110 and decides, according to the algorithms 102, whether to add the image to the library 104. The module 101 can be configured on the device 110 via software, e.g., a program. The image accessed by the device 110 can be stored on the device 110 or can be stored at an external storage/remote server and accessed via a connection between the device 110 and the external storage/remote server. The library 104 is made available to (accessible by) the application 103 for sending the user facial expression images as emoticons.

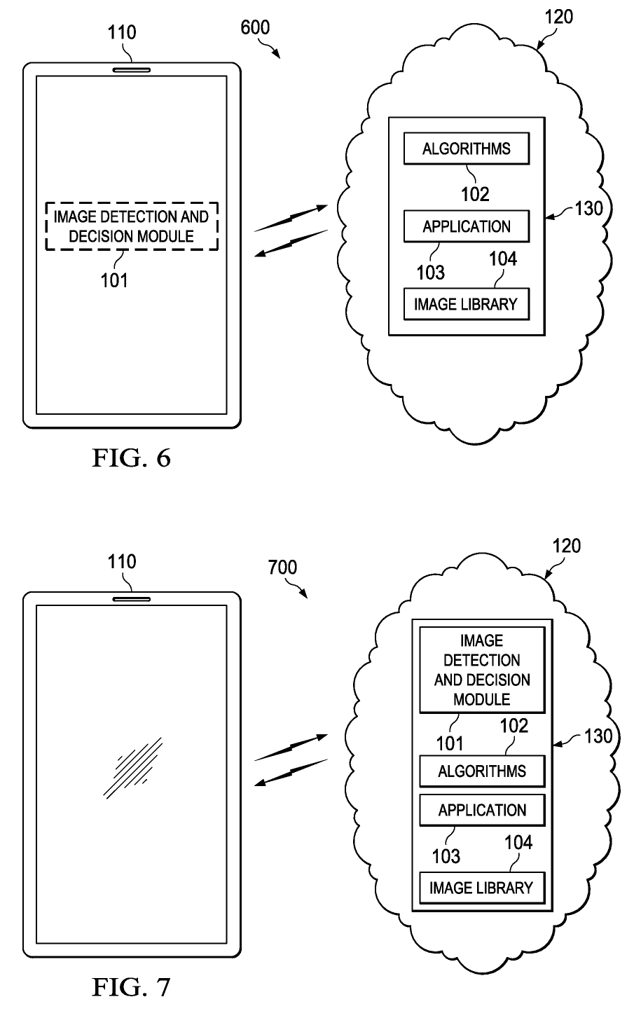

FIG. 6 illustrates an embodiment of another system 600 comprising a user device 110 that communicates with a network 120 and one or more servers 130. The user device 110 includes an image detection and decision module 101, and the one or more servers 130 comprise face and facial expression recognition algorithms 102, an application 103 (e.g., messaging or social network application), and a library of images 104 portraying the user facial expressions. The device 110 can communicate with a server 130 to access and use the application 103. In other embodiments, the module 101 is located on the device 110, while the algorithms 102, application 103, and library 104 are distributed in any suitable implementation between the user device 110 and the one or more servers 130.

Alternatively, the method of detecting a user facial image and expression and accordingly the decision to add the image to the library can be primarily implemented by a server on the network side in communications with the user device. FIG. 7 illustrates an embodiment of a system 700 comprising a user device 110 that communicates with a network 120 and one or more servers 130. The one or more servers 130 include an image detection and decision module 101, face and facial expression recognition functions or algorithms 102, an application 103 (e.g., messaging or social network application), and a library 104 of user facial expression images. The image accessed by a server 130 can be stored on the same or another server 130, on the device 110, or an external storage/remote server (not shown). The library 104 is accessible by the application 103 for sending the user facial expression images as emoticons. The user device 110 communicates with or accesses the application 103 on a server 130 for sending user facial expression images from the library 104.

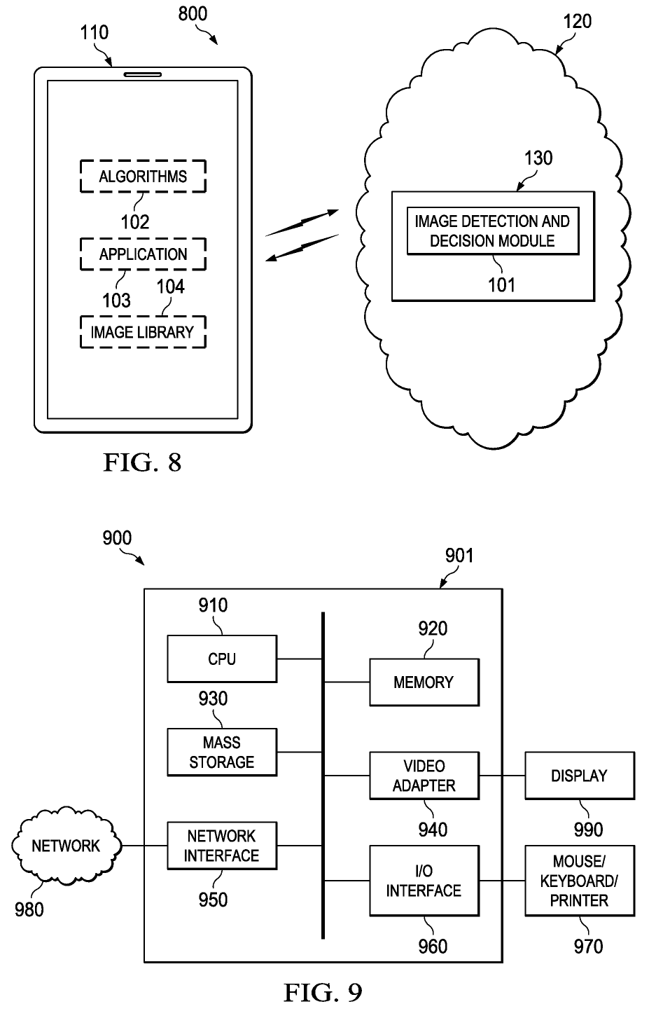

FIG. 8 illustrates an embodiment of another system 800 comprising a user device 110 which communicates with a network 120 and a server 130. The server 130 includes an image detection and decision module 101, while the user device 110 comprises face and facial expression recognition algorithms 102, an application 103, and a user facial expressions image library 104. The server 130 can communicate with the device 110 to use the algorithms 102 and accordingly add a user facial expression image to the library 104. The library 104 is accessible by the application 102 on the device 110. In other embodiments, the module 101 is located on the server 130, while the algorithms 102, application 103, and library 104 are distributed in any suitable implementation between the user device 110 and the network 120.

FIG. 9 is a block diagram of a processing system 900 that can be used to implement various embodiments. For instance the processing system 900 can be part of a user device, such as a smartphone, tablet computer, a laptop, or a desktop computer. The processing system can also be part of a server that may communicate with the user via a user device. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 900 may comprise a processing unit 901 equipped with one or more input/output devices, such as a speaker, microphone, mouse, touchscreen, keypad, keyboard, printer, display, and the like. The processing unit 901 may include a central processing unit (CPU) 910, a memory 920, a mass storage device 930, a video adapter 940, and an I/O interface 960 connected to a bus. The bus may be one or more of any type of several bus architectures including a memory bus or memory controller, a peripheral bus, a video bus, or the like.

The CPU 910 may comprise any type of electronic data processor. The memory 920 may comprise any type of system memory such as static random access memory (SRAM), dynamic random access memory (DRAM), synchronous DRAM (SDRAM), read-only memory (ROM), a combination thereof, or the like. In an embodiment, the memory 920 may include ROM for use at boot-up, and DRAM for program and data storage for use while executing programs. In embodiments, the memory 920 is non-transitory. The mass storage device 930 may comprise any type of storage device configured to store data, programs, and other information and to make the data, programs, and other information accessible via the bus. The mass storage device 930 may comprise, for example, one or more of a solid state drive, hard disk drive, a magnetic disk drive, an optical disk drive, or the like.

The video adapter 940 and the I/O interface 960 provide interfaces to couple external input and output devices to the processing unit. As illustrated, examples of input and output devices include a display 990 coupled to the video adapter 940 and any combination of mouse/keyboard/printer 970 coupled to the I/O interface 960. Other devices may be coupled to the processing unit 901, and additional or fewer interface cards may be utilized. For example, a serial interface card (not shown) may be used to provide a serial interface for a printer.

The processing unit 901 also includes one or more network interfaces 950, which may comprise wired links, such as an Ethernet cable or the like, and/or wireless links to access nodes or one or more networks 980. The network interface 950 allows the processing unit 901 to communicate with remote units via the networks 980. For example, the network interface 950 may provide wireless communication via one or more transmitters/transmit antennas and one or more receivers/receive antennas. In an embodiment, the processing unit 901 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by an electronic device associated with a user comprising:
detecting an image accessible by the electronic device;
determining whether the image shows a face of the user and whether the image shows a facial expression expressed by the face of the user;
adding the image to a library of facial expressions of the user in accordance with the determining step; and
sending a message including, as an emoticon, the image from the library.

2. The method of claim 1 further comprising:
providing an application access to the library; and
enabling the application to send the image from the library to a network or a recipient.

3. The method of claim 2, wherein the application is one of a text messaging application that sends and receives messages between the user and one or more other users, an instant messaging application that exchanges real-time messages between the user and one or more other users, and a social networking application that posts messages of the user for one or more other users to view.

4. The method of claim 2, wherein providing the application access to the library includes adding to the application an option to display the image on the electronic device.

5. The method of claim 4 further comprising:
displaying a view of user face images in the library when the user selects the option;
upon the user selecting one of the user face images, displaying the selected one of the user face images on the electronic device using the application;
sending the selected one of the user face images using the application.

6. The method of claim 5, wherein the user face images portray various facial expressions of the user.

7. The method of claim 1, wherein the image is detected upon downloading, displaying, or receiving the image on the electronic device.

8. The method of claim 1, wherein the image is detected upon turning on the electronic device.

9. The method of claim 2, wherein the determining step includes:
analyzing the image using a face recognition algorithm including the determining whether the image shows the face of the user; and
analyzing the image using a facial expression recognition algorithm including the determining whether the image shows the facial expression.

10. The method of claim 9, wherein at least one of the face recognition algorithm, the facial expression recognition algorithm, the application, and the library of facial expressions is located on the electronic device.

11. The method of claim 9, wherein at least one of the face recognition algorithm, the facial expression recognition algorithm, the application, and the library of facial expressions is accessed remotely by the electronic device.

12. The method of claim 9 further comprising enabling, on the electronic device, the face recognition algorithm and the facial expression recognition algorithm upon turning on the electronic device.

13. The method of claim 9 further comprising:
upon turning on the electronic device, prompting the user to enable the face recognition algorithm and the facial expression recognition algorithm; and
upon receiving approval by the user, enabling the face recognition algorithm and the facial expression recognition algorithm.

14. A method performed by a network server comprising:
detecting a face of a user in a digital image and a facial expression expressed by the face of the user in the digital image;
adding the digital image to a library of digital images portraying facial expressions of the user; and
providing an application operated on an electronic device of the user access to the library,
wherein the application includes an option to send, from the electronic device, the digital image as an emoticon.

15. The method of claim 14, wherein the library is stored on at least one of the network server, the electronic device of the user, and a remote storage.

16. The method of claim 14, wherein the application is one of a text messaging application that sends and receives messages between the user and one or more other users, an instant messaging application that exchanges real-time messages between the user and one or more other users, and a social networking application that posts messages of the user for one or more other users to view.

17. The method of claim 15, wherein the application is executable on the electronic device of the user and communicates with the network server to access the library.

18. The method of claim 15, wherein the application is executable on the network server or a network associated with the network server.

19. The method of claim 15, wherein the application is provided access to the library upon receiving a request by the user for displaying or sending any one of the digital images of the library.

20. The method of claim 15, wherein the network server is a cloud based server with a connection to the electronic device of the user.

21. The method of claim 15, wherein the face of the user is detected in the digital image using a face recognition algorithm, and wherein the facial expression is further detected in the digital image using a facial expression recognition algorithm.

22. The method of claim 21 further comprising analyzing the digital image using the facial expression recognition algorithm upon detecting the face of the user in the digital image using the face recognition algorithm.

23. The method of claim 21, wherein the digital image is added to the library upon detecting the facial expression in the digital image.

24. The method of claim 21, further comprising:
upon failure to detect, in the digital image, a facial expression, prompting the user to accept the digital image in the library; and
upon approval of the user, performing the adding of the digital image to the library.

25. An electronic device associated with a user comprising:
at least one processor;
a display providing the user interface; and
a non-transitory computer readable storage medium storing programming for execution by the at least one processor, the programming including instructions to:
detect an image accessible by the electronic device;
determine whether the image shows a face of a user and whether the image shows a facial expression expressed by the face of the user;
add the image to a library of facial expressions of the user in accordance with the determining step; and
send a message including, as an emoticon, the image from the library.

26. The electronic device of claim 25, wherein the programming includes further instructions to provide an application access to the library, wherein the application is one of a text messaging application that sends and receives messages between the user and one or more other users, an instant messaging application that exchanges real-time messages between the user and one or more other users, and a social networking application that posts messages of the user for one or more other users to view.

27. The method of claim 26, wherein the programming includes further instructions to:
analyze the image using a face recognition algorithm including the determining whether the image shows the face of the user; and
analyze the image using a facial expression recognition algorithm including the determining whether the image shows the facial expression.

28. The electronic device of claim 27, wherein at least one of the face recognition algorithm, the facial expression recognition algorithm, the application, and the library of facial expressions is located on the electronic device.

29. The electronic device of claim 27, wherein at least one of the face recognition algorithm, the facial expression recognition algorithm, the application, and the library of facial expressions is accessed remotely by the electronic device.

30. The electronic device of claim 25, wherein the electronic device is one of a smartphone, a tablet computer, a laptop computer, a desktop computer, and a communications device.

31. A network server comprising:
at least one processor; and
a non-transitory computer readable storage medium storing programming for execution by the at least one processor, the programming including instructions to:
detect a face of a user in a digital image and a facial expression expressed by the face of the user in the digital image;
add the digital image to a library of digital images portraying facial expressions of the user; and
provide an application operated on an electronic device of the user access to the library,
wherein the application includes an option to send, from the electronic device, the digital image as an emoticon.

32. The network server of claim 31, wherein the library is stored on at least one of the network server, the electronic device of the user, and a remote storage.

33. The network server of claim 31, wherein the application is one of a text messaging application, an instant messaging application, and a social networking applications executable on the electronic device of the user.

34. The network server of claim 31, wherein the application is one of a text messaging application, an instant messaging application, and a social networking applications executable on a network associated with the network server.

35. The network server of claim 31, wherein the network server is a cloud based server accessible remotely by the electronic device of the user.

36. A system comprising:
an electronic device associated with a user; and
one or more network servers,
wherein the electronic device and the one or more network servers are individually or collectively configured to:
detect an image accessible by the electronic device;
determine whether the image shows a face of the user and whether the image shows a facial expression expressed by the face of the user; and
add the image to a library of facial expressions of the user in accordance with the determining step,
wherein the library is accessible by an application operated on the electronic device associated with the user, and
wherein the application includes an option to send, from the electronic device, the digital image as an emoticon.

37. The system of claim 36, wherein the electronic device is configured to detect the image.

38. The system of claim 36, wherein the one or more network servers are configured to detect the image.

39. The system of claim 36, wherein the electronic device is configured to analyze the image using at least one of a face recognition algorithm and a facial expression recognition algorithm.

40. The system of claim 36, wherein the one or more network servers are configured to analyze the image using at least one of a face recognition algorithm and a facial expression recognition algorithm.

41. The system of claim 36, wherein the electronic device and the one or more network servers are individually or collectively further configured to provide access to library to at least one of a text messaging application, an instant messaging application, and a social networking applications accessible remotely on the electronic device.

42. The system of claim 36, wherein the programing includes further instructions to provide access to the library access to at least one of a text messaging application, an instant messaging application, and a social networking application located on the electronic device.

43. The system of claim 36, wherein the one or more network servers are operated by a service provider or a network operator.

44. The system of claim 43, wherein the electronic device is capable of communicating with the one or more network servers via one of a cellular link and a WiFi link.

45. The system of claim 36, wherein the one or more network servers are operated by an Internet service provider or a cloud service provider.
